(19) United States
(12) Patent Application Publication
(10) Pub. No.: US 2003/0151777 A1
(43) Pub. Date: Aug. 14, 2003

(54) FACSIMILE APPARATUS AND METHOD OF CONTROLLING THE SAME

(76) Inventors: TATSUYA. NISHIO, NARA-SHI (JP); FUMIAKI KOBAYASHI, YAMATOKORIYAMA-SHI (JP)

Correspondence Address: EDWARDS & ANGELL, LLP, P.O. BOX 9169, BOSTON, MA, 02209, US

(21) Appl. No.: 09/296,033

(22) Filed: Apr. 21, 1999

(30) Foreign Application Priority Data
Apr. 21, 1998 (JP) 10/111127

(51) Int. Cl. H04N 1/32

(52) U.S. Cl. 358/468

(57) ABSTRACT

Setting operation in controlling a facsimile apparatus by a personal computer or the like is facilitated, and settings for adapting the facsimile apparatus to many destination areas and specifications are executed in a uniform manner. A facsimile apparatus is connected to a personal computer or the like in a wireless state via an infrared port or in a wired state via an RS232C connector so as to allow information communication with the personal computer. When application software for controlling the facsimile apparatus is installed in the personal computer, PC-FAX setting information previously set in a ROM is transmitted to the personal computer via information communication, so that setting of the application software is automatically executed.

### BACKGROUND OF THE INVENTION

1. Field of the Invention

The present invention relates to a facsimile apparatus capable of transmitting/receiving information to and from an information processing apparatus such as a personal computer, which facsimile apparatus can be controlled by application software installed in the information processing apparatus, and to a method of controlling the same.

2. Description of the Related Art

Facsimile apparatuses, which can easily transmit image data, are becoming increasingly common all over the world. For enhancing convenience, most facsimile apparatuses are usually provided with several functions, for example, a function that transmitting speed, compression protocol, image quality or the like can be set by a user to adapt them to conditions of a place where the facsimile apparatus is installed; a function that destinations which are frequently communicated with the subject facsimile apparatus can be pre-registered.

For the purpose of further enhancing the convenience in using a facsimile apparatus and realizing a more advanced application of facsimile apparatuses, facsimile apparatuses are often connected to an external information processing apparatus such as a personal computer. Such prior art of connecting a facsimile apparatus to an external information processing apparatus is disclosed, for example, in Japanese Unexamined Patent Publications JP-A 8-265468 (1996) and JP-A 8-340411 (1996). In the prior art disclosed in JP-A 8-265468, for example, an inquiry about specifications in connection with registration of one-touch dialing operation or the like of a facsimile apparatus is issued from the side of a personal computer connected thereto, and a response to the inquiry is sent from the facsimile apparatus side to the personal computer side, whereby a one-touch dialing operation of the facsimile apparatus in accordance with the specifications is registered from the personal computer side. JP-A 8-340411 discloses that a FAX modem having a facsimile function is connected to a personal computer and a circuit terminal for connecting the FAX modem to a telephone circuit or the like and an expansion terminal provided in a facsimile apparatus are connected to each other, whereby the facsimile apparatus can be used as a scanner or printer for the personal computer. In some cases, specific software is provided for a facsimile apparatus for use in a personal computer as an application program for controlling the facsimile apparatus.

Also, such application software is used that enables a personal computer to be connected with a FAX modem and thereby to be used as a facsimile apparatus. In the case of using such application software, it is necessary to obtain information regarding specifications e.g. transmission speed, compression protocol, image quality of the facsimile apparatus to be connected on the application software side. Information regarding specifications for typical FAX modems are previously stored in the application software, so as to be selected in accordance with the model of FAX modem. In the case where a FAX modem is one produced later than the application software, information related to specifications is not available, and therefore setting by a user or version up of the application software is necessary.

In the prior art disclosed in JP-A 8-265467, when application software for registration operation is installed or when a personal computer on which the application software is installed is booted, setting items for a facsimile apparatus are automatically displayed in a registration display, allowing a user to conduct a setting operation. Then, setting contents input by the user in accordance with the registration display are transmitted to the facsimile apparatus to accomplish registration. In this case, the setting contents are familiar to users such as called parties to be called by use of one-touch dialing, and vary from user to user. When the destination country of the facsimile apparatus is changed, circuit standards therefor may change, however, it is difficult for general users to change various parameters of facsimile apparatus in accordance with information regarding the changed circuit standards. Even if a screen operable to make such settings is displayed by application software, allowing the user to conduct setting in the same manner as registration of one-touch dialing, it is still difficult for general users to conduct such setting because they need detail technical knowledge regarding facsimile communication to execute such setting accurately. For this reason, it is necessary that the application software previously hold information for automatic setting and execute setting of the facsimile apparatus automatically. However, commercially available general-purpose application software conforms only to circuit standards of a country where the application software is on sale.

Even in the case of specific software attached to a facsimile apparatus, when the destination country of the facsimile apparatus is changed and accordingly the circuit standards are changed, it is necessary to newly develop a version of the software specifically for the destination country because there is no procedure to obtain information regarding the circuit standards. In changing the destination country or specifications of a facsimile apparatus, it is necessary to install a version of application software specific for the destination country so as to control the facsimile apparatus.

Furthermore, in order to control a facsimile apparatus effectively from a personal computer, it is required that application software also grasps data such as specifications of the facsimile appropriately. As for the prior art or general application software, however, this is effected by the user directly setting information or selecting necessary data from previously created data in accordance with the model of the facsimile apparatus.

### SUMMARY OF THE INVENTION

It is an object of the invention to provide a facsimile apparatus in which a setting for controlling the facsimile apparatus can be automatically made by application software of a personal computer or the like, and which can correspond to changes in destination country, specifications or the like readily, and to provide a control method of the same.

The present invention provides a facsimile apparatus which is connectable to an external information processing apparatus and controllable by application software installed in the information processing apparatus, the facsimile apparatus comprising:

a storage circuit for previously storing setting information of the application software including information related to specifications and destination countries of the facsimile apparatus; and

a sending circuit for reading out the setting information from the storage circuit and sending the setting information to the information processing apparatus at the time of predetermined operation of the application software in the information processing apparatus.

According to the invention, the storage circuit of the facsimile apparatus previously stores the setting information of application software including information related to specifications and destination countries of the facsimile apparatus, which setting information is required by the application software installed in the external information processing apparatus connected to the facsimile apparatus. Since the transmitting circuit transmits the setting information stored in the storage circuit to the information processing apparatus at the time of predetermined operation of the application software, control may be executed in a suitable manner for the facsimile apparatus actually connected.

According to the invention, since the application software specific for facsimile apparatuses installed in the information processing apparatus can automatically acquire the setting information including information related to specifications and destination countries of the facsimile apparatus from the facsimile apparatus, the facsimile apparatus can be controlled readily by the information processing apparatus. There is no need for the application software specific for facsimile apparatuses to store setting information regarding specifications of plural destination countries for individual facsimile apparatuses in advance, and therefore, the application software for controlling facsimile apparatuses may be generalized and unified.

Also, the invention provides a facsimile apparatus which is connectable to an external information processing apparatus and controllable by application software installed in the information processing apparatus, the facsimile apparatus comprising:

a receiving circuit for receiving information to be set in the facsimile apparatus from the information processing apparatus at the time of predetermined operation of the application software in the information processing apparatus; and

a setting circuit for making a setting of the facsimile apparatus with the information received by the receiving circuit.

According to the invention, the information to be set in the facsimile apparatus is transmitted to the facsimile apparatus from the information processing apparatus at the time of predetermined operation of the application software in the information processing apparatus. Then, the facsimile apparatus receives the transmitted information with the receiving circuit and makes a setting by use of the information with the setting circuit. Accordingly, there is no need for the facsimile apparatus to arrange all the possible information to be used initially, but the setting can be made automatically from the application software of the information processing apparatus.

Also according to the invention, information to be set in the facsimile apparatus may be automatically set from the application software installed in the information processing apparatus connected to the facsimile apparatus so as to allow information communication. As a result, control of the facsimile apparatus by the application apparatus can be readily executed.

The invention is characterized in that the time of predetermined operation is when the application software is installed in the information processing apparatus.

According to the invention, it is possible to automatically transmitting and setting information required for the application software or facsimile apparatus when the application software is installed in the information processing apparatus.

Also according to the invention, it is possible to make a setting of necessary information when the application software is installed in the information processing apparatus. In the case where the application software is recorded in a large capacity recording medium to be read by the information processing apparatus, a great many types of facsimile apparatus supported by the application software can be recorded, and in such a case, only necessary information may be used at the time of installation.

The invention is characterize in that the time of predetermined operation is when the application software is booted in the information processing apparatus.

According to the invention, it is possible to make a necessary setting thorough information communication between the information processing apparatus and the facsimile apparatus every time the information processing apparatus boots the application software after installation of the application software on the information processing apparatus.

Also according to the invention, necessary setting can be made at the time of booting the application software installed in the information processing apparatus. As a result, even when there is a change in contents of setting, a setting may be made automatically in accordance with the change in contents.

The invention further provides a method for controlling a facsimile apparatus from the side of an information processing apparatus, the information processing apparatus being connected to the facsimile apparatus so as to allow information communication, the method comprising the steps of:

previously storing setting information including information related to specifications and destination countries of the facsimile apparatus, on the facsimile apparatus side;

transmitting the setting information from the facsimile apparatus side to the information processing apparatus side via information communication at the time of predetermined operation of the information processing apparatus side; and

installing a program for controlling the facsimile apparatus on the information processing apparatus as application software, to thereby control the facsimile apparatus from the information processing apparatus side based on the setting information transmitted via information communication.

According to the invention, when a facsimile apparatus which is connected to an information processing apparatus so as to allow information communication is controlled by application software installed in the information processing apparatus, setting information required for the application software is previously stored on the facsimile apparatus side and the setting information is transmitted to the information processing apparatus from the facsimile apparatus when the application software is installed in the information processing apparatus. Thus, the application software can acquires setting information regarding individual facsimile apparatuses automatically, which makes it possible to generalize and unify the application software.

Also according to the invention, when a facsimile apparatus which is connected to an information processing apparatus so as to allow information communication is controlled by application software installed in the information processing apparatus, information required for the control is automatically transmitted from the facsimile apparatus to the information processing apparatus at a predetermined time. Accordingly, there is no need to prepare application software in correspondence with individual facsimile apparatuses, which makes it possible to generalize and unify the application software.

The invention further provides a method for controlling a facsimile apparatus from the side of an information processing apparatus, the information processing apparatus being connected to the facsimile apparatus so as to allow information communication, the method comprising the steps of:

installing a program for controlling the facsimile apparatus on the information processing apparatus as application software;

transmitting information to be set in the facsimile apparatus via information communication from the information processing apparatus side to the facsimile apparatus side at the time of predetermined operation of the information processing apparatus side; and

making a setting of the facsimile apparatus with the transmitted information on the facsimile apparatus side.

According to the invention, the facsimile apparatus and the information processing apparatus are connected so as to allow information communication, whereby information to be set in the facsimile apparatus is automatically transmitted from the application software installed in the information processing apparatus to the facsimile apparatus to be set therein. Therefore, even in the case where specifications or operation conditions of the facsimile apparatus are changed, control of the facsimile apparatus by the application software can be readily executed because the setting is made by the application software automatically.

Also according to the invention, the facsimile apparatus and the information processing apparatus are connected to each other so as to allow information communication, and the information to be set in the facsimile apparatus is automatically transmitted from the application software installed in the information processing apparatus to the facsimile apparatus to be set therein at a predetermined time. Accordingly, conditions associated with particular destination country of the facsimile apparatus can be readily set.

The invention is characterized in that the time of predetermined operation is when the application software is installed in the information processing apparatus.

According to the invention, when the application software is installed in the information processing apparatus, a necessary setting can be made via information communication between the information processing apparatus and the facsimile apparatus.

Also according to the invention, the facsimile apparatus and the information communication apparatus are connected to each other so as to allow information communication, and a setting necessary for control can be made when the application software for controlling the facsimile apparatus is installed in the information processing apparatus, so that it is possible to make a necessary setting automatically.

Further, the invention is characterized in that the time of predetermined operation is when the application software is booted in the information processing apparatus.

According to the invention, when the application software installed in the information processing apparatus is booted, a necessary setting can be made via information communication between the information processing apparatus and the facsimile apparatus, so that it is possible to control facsimile control based on the latest data.

According to the invention, the facsimile apparatus and the information processing apparatus are connected to each other so as to allow information communication, and the facsimile apparatus is controlled by the application software installed in the information processing apparatus. Thus, since a setting required for control is made when the application software is booted, the facsimile apparatus is readily made to correspond to changes in setting condition or the like.

### BRIEF DESCRIPTION OF THE DRAWINGS

Other and further objects, features, and advantages of the invention will be more explicit from the following detailed description taken with reference to the drawings wherein:

FIG. 1 is a block diagram showing a schematic logical configuration of a facsimile apparatus 1 according to one embodiment of the present invention;

FIG. 2 is a block diagram showing a schematic logical configuration of a PC 21 capable of information communication with the facsimile apparatus 1 of FIG. 1;

FIG. 3 is a flow chart showing operation procedures of the PC 21 and the facsimile apparatus 1 when installing a PC-FAX control program on the PC 21 of FIG. 2; and

FIG. 4 is a flow chart showing operation procedures of the PC 21 and the facsimile apparatus 1 when installing a PC-FAX control program on the PC 21 in another embodiment of the invention.

### DETAILED DESCRIPTION OF THE PREFERRED EMBODIMENTS

Now referring to the drawings, preferred embodiments of the invention are described below.

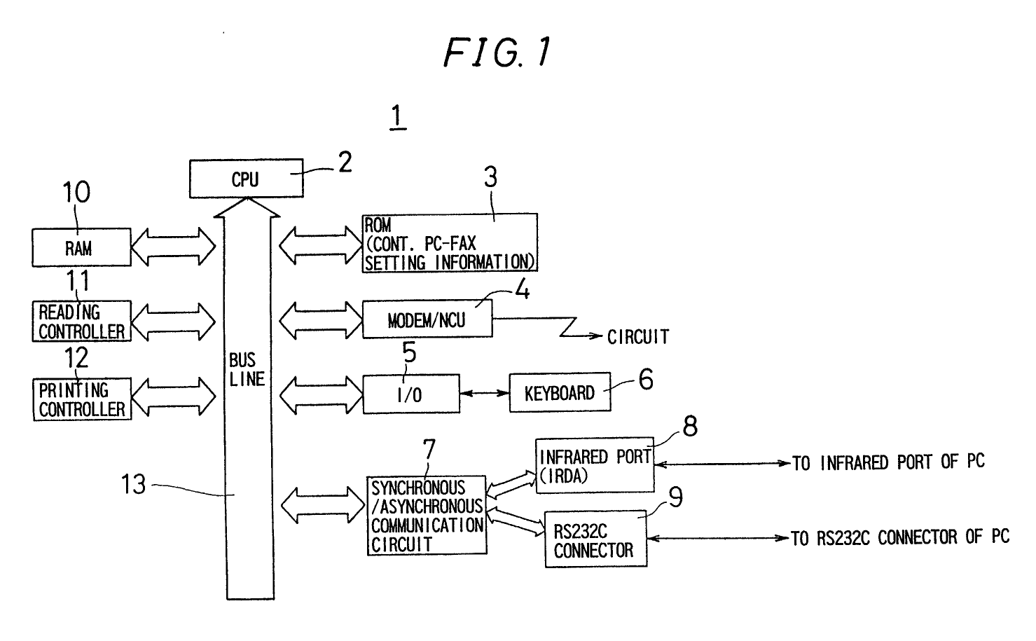

FIG. 1 shows a schematic logical configuration of a facsimile apparatus 1 according to one embodiment of the present invention. A CPU 2 controls the whole facsimile apparatus 1 in accordance with a control program previously stored in a ROM 3. A modem/NCU 4 converts image data for communication to send it to a circuit such as a public telephone circuit, and converts facsimile communication data received from the circuit into a form that can be recognized in a program operation of CPU 2. NCU is an abbreviation for ‘network control unit.’ An interface 5 (hereinafter, abbreviated as ‘I/O’) is provided for inputting key manipulation of a user made on a keyboard 6 to the CPU 2 so as to be operated by the program operation of CPU 2. A synchronous/asynchronous communication circuit 7 is connected to interfaces for transmitting information from/to external peripheral devices. As the interfaces, an infrared port 8 for wireless information communication, an RS232C connector 9 for wired information communication and the like can be connected.

In the program operation of the CPU 2, a RAM 10 is used for storing data and for storing information for control. The facsimile apparatus 1 is further provided with a reading controller 11 for reading a document in the normal usage condition of the facsimile apparatus 1 and a printing controller 12 for outputting received image data. The printing controller 12 has not only a function of printing received facsimile data but also a copying function of printing out contents of the document read by the reading controller 11 as they are, and a function of printing various lists of setting of the facsimile apparatus 1. The CPU 2 is connected with the ROM 3, modem/NCU 4, I/O 5, synchronous/asynchronous communication circuit 7, RAM 10, reading controller 11 and printing controller 13 via a bus line 13. The infrared port 8 or the RS232C connector 9 can be connected to an external information processing apparatus such as a personal computer for controlling the facsimile apparatus 1.

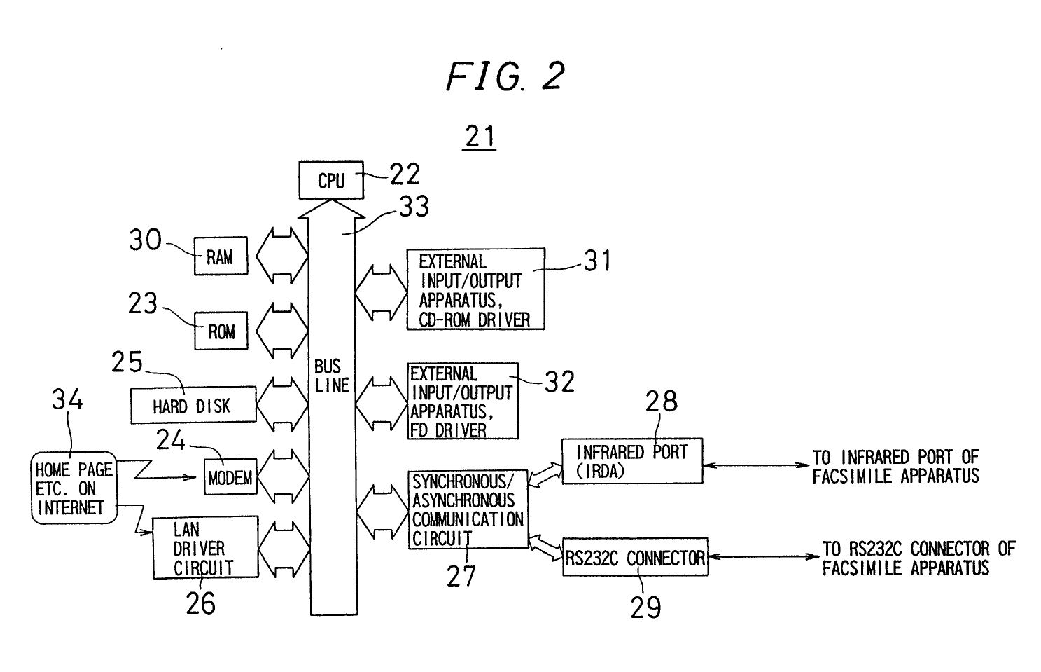

FIG. 2 shows a schematic logical configuration of a personal computer (hereinafter, abbreviated as ‘PC’) 21 connectable to the facsimile apparatus 1 of FIG. 1. A CPU 22 controls the whole PC 21 apparatus, and a program for controlling the PC 21 is previously stored in a ROM 23. A modem 24 is provided for connecting the PC 21 with an external public telephone circuit or the like. A hard disk 25 is used for storing an operating system (OS) of the PC 21, application software installed in the PC 21, and the like. A LAN driver circuit 26 functions as an interface necessary for forming a local area network (LAN). A synchronous/asynchronous communication circuit 27 controls ports which execute communications between the PC and external peripheral devices. To the synchronous/asynchronous communication circuit 27, further connected an infrared port 28, an RS232C connector 29 and the like, thereby allowing information communication with the facsimile apparatus 1 of FIG. 1, i.e., with the infrared port 8 or RS232C connector 9 in a wireless or wired state, respectively. In order to achieve high-speed operation, the CPU 22 executes the operation after having read a program to be actually used into a memory space of a RAM 30. As external input/output apparatuses 31, 32, a CD-ROM driver and a FD driver are connected, respectively, to which a CD-ROM and a FD (floppy disk) serving as recording media of programs and data are mounted detachably. The CPU 22 is connected with the ROM 23, modem 24, hard disk 25, LAN driver circuit 26, synchronous/asynchronous communication circuit 27, RAM 30 and external input/output apparatuses 31, 32 via a bus line 33. The modem 24 or the LAN driver circuit 26 is connectable to an internet circuit 34 on which home pages and the like are provided.

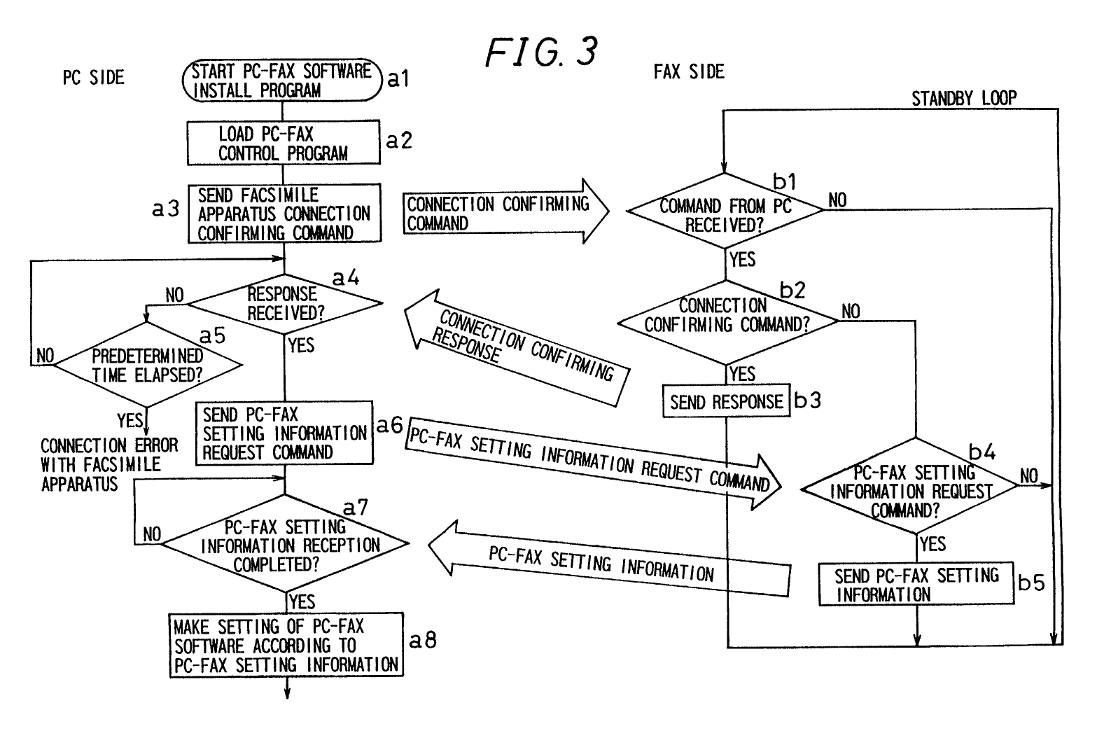

FIG. 3 shows procedures of installing application software so that control of the facsimile apparatus 1 of FIG. 1 may be executed by using the application software installed in the PC 21 of FIG. 2, in which procedures on the PC 21 side and on the facsimile apparatus 1 side. In installing PC-FAX software serving as application software for controlling the facsimile apparatus 1 on the PC 21, at first, a program for installing the PC-FAX software is started up on the PC 21 in step a1. The PC-FAX software and other software for installation may be loaded with a CD-ROM or a FD serving as a recording medium being inserted into the external input/output apparatus 31, 32 of FIG. 2, or may be downloaded from the internet circuit 34 via the modem 24 or the LAN driver circuit 26. When the install program is started up in step a1, the PC-FAX control program is read out and loaded in step a2. In step a3, a command for confirming connection with the facsimile apparatus 1 is sent out. Instep a4, it is determined whether a response from the facsimile apparatus 1 is received. In the case where a response is not received, it is determined whether a predetermined time has elapsed in step a5. In the case where the predetermined time has elapsed, it is judged as a connection error with the facsimile apparatus 1, and error indication or the like is made. In the case where a response is received in step a4, a PC-FAX setting information request command is sent to the facsimile apparatus 1 in step a6 so that setting information based on the specifications of the facsimile apparatus 1 may be programmed in the PC-FAX software serving as the application software. In step a7, the PC 21 receives PC-FAX setting information from the facsimile apparatus 1 and waits until the reception is completed. Upon completion of the reception, setting of the PC-FAX software is made in accordance with the received PC-FAX setting information in step a8, and control of the facsimile apparatus 1 according to the set information is started by the PC-FAX software.

On the facsimile apparatus 1 side, a standby loop is repeated until a command from the PC 21 is received in step b1. When the connection confirming command sent out in step a3 is received at first, the flow proceeds to step b2 and whether the received command is a connection confirming command is determined. When it is judged as a connection confirming command, a response is sent out in step b3. This response is confirmed in step a4 on the PC 21 side. After sending the response in step b3, the facsimile apparatus 1 returns to step b2 and continues the standby loop. In other words, when a command from the PC 21 is not received in step b1, the flow returns to step b1 again. In the case where the PC 21 sends out a PC-FAX setting information request command in step a6, it is judged in step b1 that a command from the PC 21 is received, and it is judged in step b2 that the received command is not a connection confirming command. Then the flow proceeds to step b4. Since the received command is judged as a PC-FAX setting information request command in step b4, PC-FAX setting information is sent out in step b5, thereafter the flow returns to step b1. The PC-FAX setting information sent out in step b5 is received in step a7 of the PC 21. Incidentally, when it is judged as not being a PC-FAX setting information request command in step b4, the flow returns to step b1.

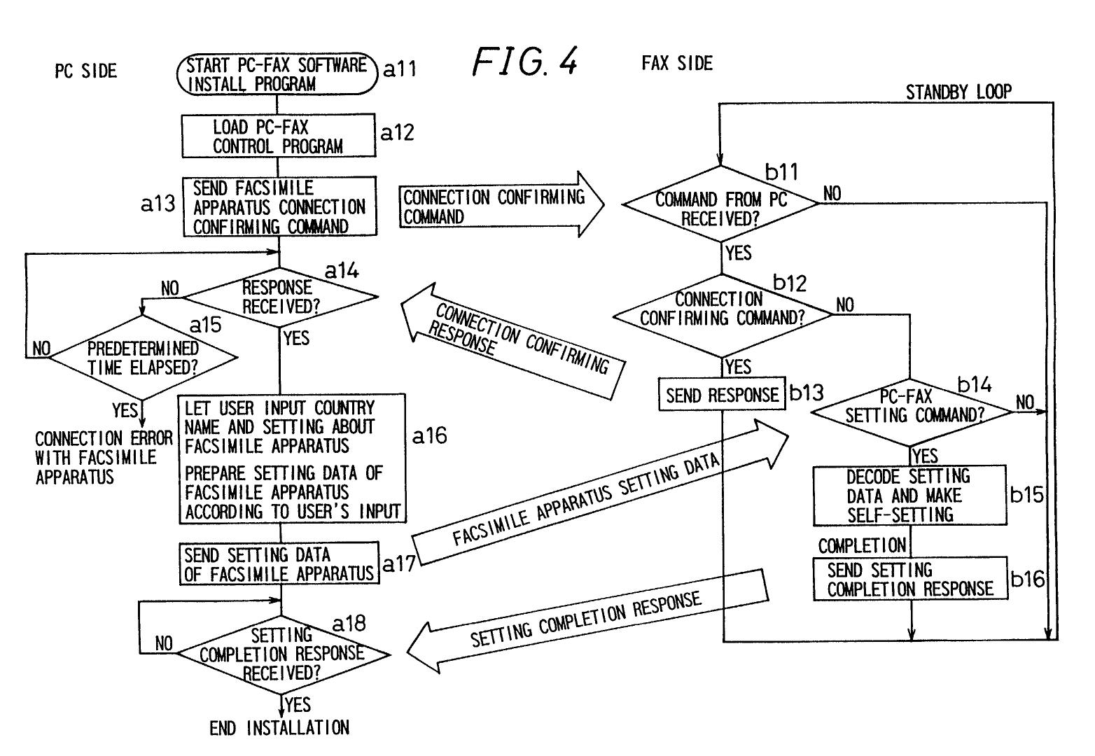

FIG. 4 shows operation procedures of the PC 21 and the facsimile apparatus 1 in installing the PC-FAX control program serving as application software on the PC 21 in another embodiment of the invention. In the operation procedure of FIG. 4, similar operations to those in step a1 to a5 of FIG. 3 are executed in steps a11 to a15. In step a16, a user of the facsimile apparatus 1 inputs a name of country or settings regarding the facsimile apparatus. In the case where the PC-FAX control program is installed by downloading from a large capacity CD-ROM or a network, a plenty of information is displayed on the screen to enable the user to select the displayed information. The PC-FAX control program prepares data to be set in the facsimile apparatus 1 according to the user's input. Next, in step a17, the setting data to be set in the facsimile apparatus 1 is sent out to the facsimile apparatus 1. In step a18, the PC 21 waits for receiving a setting completion response from the facsimile apparatus 1, and completes the installation upon reception of the setting completion response.

In an operation procedure of the facsimile apparatus 1 executed in correspondence with the operations of the PC 21 during the installation as shown in FIG. 4, steps b11 to b13 correspond to steps b1 to b3 of FIG. 3, respectively. When the command is judged as not being a connection confirming command in step 12, the flow proceeds to step b14 and whether the command is a PC-FAX setting command or not is determined. This PC-FAX setting command is sent from the PC 21 together with the setting data for facsimile apparatus in step a17. When it is judged in step b14 that the command is a PC-FAX setting command, the setting data is decoded and setting of the facsimile apparatus 1 is executed in step b15. Upon completion of the setting, a setting completion response is sent to the PC 21 in step b16. The PC 21 receives the setting completion response in step a18. When the procedure ends in step b6, or when it is judged in step b14 that the command is not a PC-FAX setting command, the flow returns to step b11.

In the embodiment of FIG. 3 or 4, settings regarding the PC-FAX control program itself or the facsimile apparatus 1 are made when the PC-FAX control program serving as application software is installed in the PC 21, however, it is also possible to update the setting information based on information communication between the facsimile apparatus 1 and the PC 21 at the time of booting of the PC-FAX control program installed in the PC 21, to thereby change the setting automatically in accordance with change in setting information made after the installation of the program.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A facsimile apparatus-connectable to an external information processing apparatus and controllable by application software installed in the information processing apparatus, the facsimile apparatus comprising:
a storage circuit for previously storing setting information of application software including information related to specifications and destination countries of the facsimile apparatus; and
a sending circuit for reading out the setting information from the storage circuit and sending the setting information to the information processing apparatus at a time when a predetermined operation of the application software in the information processing apparatus is carried out.

2. A facsimile apparatus connectable to an external information processing apparatus and controllable by application software installed in the information processing apparatus, the facsimile apparatus comprising:
a receiving circuit for receiving information to be set in the facsimile apparatus from the information processing apparatus at a time when a predetermined operation of application software in the information processing apparatus is carried out; and
a setting circuit for making a setting of the facsimile apparatus with the information received by the receiving circuit.

3. The facsimile apparatus of claim 1, wherein the time of the predetermined operation is when the application software is installed into the information processing apparatus.

4. The facsimile apparatus of claim 2, wherein the time of the predetermined operation is when the application software is installed into the information processing apparatus.

5. The facsimile apparatus of claim 1, wherein the time of the predetermined operation is when the application software is booted in the information processing apparatus.

6. The facsimile apparatus of claim 2, wherein the time of the predetermined operation is when the application software is booted in the information processing apparatus.

7. A method for controlling a facsimile apparatus from the side of an information processing apparatus, the information processing apparatus being connected to the facsimile apparatus so as to allow information communication, the method comprising the steps of:
previously storing setting information including information related to specifications and destination countries of the facsimile apparatus, on the facsimile apparatus side;
transmitting the setting information from the facsimile apparatus side to the information processing apparatus side by information communication at the time of a predetermined operation on the information processing apparatus side; and
installing a program for controlling the facsimile apparatus into the information processing apparatus as application software, to thereby control the facsimile apparatus from the information processing apparatus side on the basis of the setting information transmitted by the information communication.

8. A method for controlling a facsimile apparatus from the side of an information processing apparatus, the information processing apparatus being connected to the facsimile apparatus so as to allow information communication, the method comprising the steps of:
installing a program for controlling the facsimile apparatus into the information processing apparatus as application software;
transmitting information to be set in the facsimile apparatus by information communication from the information processing apparatus side to the facsimile apparatus side at the time of a predetermined operation on the information processing apparatus side; and
making a setting of the facsimile apparatus with the transmitted information on the facsimile apparatus side.

9. The method for controlling a facsimile apparatus of claim 7, wherein the time of the predetermined operation is when the application software is installed into the information processing apparatus.

10. The method for controlling a facsimile apparatus of claim 8, wherein the time of the predetermined operation is when the application software is installed into the information processing apparatus.

11. The method for controlling a facsimile apparatus of claim 7, wherein the time of the predetermined operation is when the application software is booted in the information processing apparatus.

12. The method for controlling a facsimile apparatus of claim 8, wherein the time of the predetermined operation is when the application software is booted in the information processing apparatus.
